(19) United States
(12) Patent Application Publication
(10) Pub. No.: US 2024/0335849 A1
(43) Pub. Date: Oct. 10, 2024

(54) DISPENSING SYSTEM

(71) Applicant: Giacomo SEBASTIANI, Lugo (Ravenna) (IT)

(72) Inventor: Giacomo SEBASTIANI, Lugo (Ravenna) (IT)

(21) Appl. No.: 18/577,952

(22) PCT Filed: Jul. 12, 2022
(86) PCT No.: PCT/IB2022/056409

§ 371 Date: Jan. 9, 2024

(30) Foreign Application Priority Data
Jul. 14, 2021 (IT) 102021000018521

(51) Int. Cl. B05B 11/00; B05B 11/02

(52) U.S. Cl. CPC B05B 11/0008; B05B 11/026

(57) ABSTRACT

A system for dispensing a liquid product, including:
a pouch, made from film material, including at least a first wall, a second wall and a base wall, the pouch including a first weld, a second weld and a third weld, the first wall, the second wall and the base wall delimiting a containing space holding the liquid product, the first wall and the second wall defining an opening in the pouch at the second end;
a bushing inserted in the opening;
a sprayer for dispensing the liquid product from the pouch, the sprayer being coupled to the bushing and comprising a pumping assembly, a lever for driving the pumping assembly, a diffuser unit in communication with the pumping assembly.

### TECHNICAL FIELD

This invention relates to a dispensing system for dispensing a liquid product, such as, for example, a surface detergent, to which specific reference is made below without loss of generality.

### BACKGROUND ART

Typically, prior art dispensing systems comprise a container, normally a rigid bottle, suitably shaped to be gripped in one hand, and a sprayer which allows the detergent to be dispensed.

Usually, to make it easier to dispense and control the quantity of detergent dispensed, the sprayers used are what have become known as “trigger sprayers”.

Generally, the sprayer is screwed onto the neck of the bottle and is provided with a hose that extends into the body of the bottle to draw out the product and feed it to the sprayer which actually dispenses/sprays it.

Prior art bottles are usually rigid and made from plastic materials; rigid bottles occupy a non-negligible amount of space, which makes it more complicated to dispose of the bottle once the product it contains is finished.

Document U.S. Pat. No. 20,143,46252 discloses a dispensing system where the bottle is replaced by a bag comprising four walls and a floor panel connected to each other to form a closed interior containing the product to be dispensed.

Document DE2992087 discloses a dispensing system comprising a bag, a rigid plastic handgrip screwed to the bag and a sprayer applied to the handgrip.

Manufacturing prior art dispensing systems requires considerable quantities of plastic material, especially if the quantities are considered in terms of eco-sustainability.

There is therefore a need to reduce the quantity of plastic used to manufacture detergent dispensing systems while at the same time ensuring they remain practical and handy.

### Aim of the Invention

This invention has for an aim to meet at least the above mentioned need by proposing a compact dispensing system whose production, compared to prior art solutions, requires a smaller quantity of plastic material.

The invention, as characterized in the independent claim, achieves at least this aim.

The dependent claims correspond to possible different embodiments of the invention.

According to an aspect, this disclosure regards a dispensing system for dispensing a liquid product, such as, for example, a surface detergent.

According to an aspect, the dispensing system comprises a pouch made from sheet material or film.

According to an aspect, the pouch may comprise monomaterial film and/or multimaterial film and/or polylaminated film.

Polylaminated film is an impermeable material which comprises two or more layers of different materials.

For example, polylaminated film may comprise paper and/or plastic material and/or aluminium.

The plastic material may be low-density polythene or a multimaterial comprising, for example, low-intensity polythene, polypropylene and nylon.

Preferably, the pouch of monolayer film is monomaterial.

Advantageously, the production of a pouch using a film of plastic material means less plastic is needed compared to rigid plastic bottles.

The pouch constitutes a flexible container for the liquid product.

The pouch has a first end, for example, at the bottom, a second end, for example, at the top, and a main direction of extension.

According to an aspect, the pouch comprises at least a first wall, a second wall and a base wall lying between the first wall and the second wall at the first end.

In use, the first end of the pouch defines a supporting portion of the dispensing system.

According to an aspect, the pouch comprises a weld that joins the first wall to the second wall.

According to an aspect, the pouch comprises a weld that joins the first wall to the base wall, and a weld that joins the second wall to the base wall.

According to an aspect, the dispensing system is supported at the welds between the first and the second wall and the base wall.

According to an aspect, the base wall and the welds between the base wall and the first and the second wall define a supporting portion for the dispensing system.

According to an aspect, the first wall, the second wall and the base wall delimit a containing space holding the liquid product.

Advantageously, unlike conventional rigid bottles, a pouch made this way is easy to flatten when it is empty and no longer contains any liquid product, thus reducing the space occupied by the dispensing system and facilitating its disposal as waste.

According to an aspect, the first wall and the second wall define an opening in the pouch, at the second end.

Advantageously, the opening allows the product to pass so it can be dispensed during use.

According to an aspect, the dispensing system, comprises a bushing inserted in the opening, positioned between the first and the second wall.

According to an aspect, the first and the second wall are joined to the bushing at the opening.

According to an aspect, the bushing may comprise a collar.

According to an aspect, the dispensing system comprises a weld that joins the first and the second wall to the bushing.

According to an aspect, the bushing comprises at least a first ring protruding radially from the bushing itself.

According to an aspect, the bushing comprises a second ring protruding radially from the bushing itself.

According to an aspect, the second ring, together with the first ring, delimits an annular groove which is preferably symmetrical about the axis of symmetry of the bushing.

Advantageously, the first and the second ring of the bushing allow the pouch to be filled by industrial machinery; in effect, the pouch can be held at the groove.

Advantageously, filling the pouch industrially allows marketing a dispensing system that is ready-filled with liquid product.

Advantageously, once filled with product, the dispensing system is ready for sale off the shelf in large distribution chains.

According to an aspect, the dispensing system comprises a sprayer, for example, of the type known as “trigger sprayer” to dispense the liquid product contained in the pouch.

Advantageously, using a sprayer allows distributing and regulating the amount of detergent dispensed from the pouch to the surfaces.

According to an aspect, the sprayer is coupled to the pouch at the bushing and positioned on the side opposite the pouch.

According to an aspect, the sprayer comprises a pumping assembly, a lever for driving the pumping assembly, a diffuser unit in communication with the pumping assembly.

According to an aspect, the pumping assembly comprises a hose for drawing the liquid from the pouch.

According to an aspect, the length of the hose is greater than the height of the pouch. In other words, the hose is longer than the first and the second wall which at least partly delimit the pouch.

Advantageously, providing the dispensing system with a hose that is longer than the height of the pouch facilitates the stability of the dispensing system, in particular when the product is nearly finished.

According to an aspect, the pouch has a taper towards the second end, that is, towards the sprayer.

In other words, starting from the base wall, the pouch becomes narrow in the direction of the opening and at the opening.

According to an aspect, the taper defines a handgrip portion for the dispensing system.

Advantageously, defining a handgrip portion this way makes it easier to hold the dispensing system, that is, the pouch and the sprayer at the lever that drives the sprayer.

Advantageously, the upward taper of the pouch allows making the dispensing system more stable, not only when the pouch is full of product but also when the product is nearly finished.

According to an aspect, the weld between the first and the second wall delimits the same contouring on the first and the second wall.

According to an aspect, the bushing has an axis of symmetry.

According to an aspect, the first and the second wall are symmetrical about the axis of symmetry of the bushing.

Advantageously, the shape of the first wall and of the second wall (delimited, for example, by the welds) makes the dispensing system more ergonomic.

According to an aspect, the base wall has an axis of symmetry.

According to an aspect, the axis of symmetry of the base wall is parallel to the axis of symmetry of the bushing.

Advantageously, having a symmetrical base wall, combined with the welds, makes the dispensing system more stable, especially when the liquid product is nearly finished.

According to an aspect, the weld that joins the first and the second wall comprises a first stretch and a second stretch extending from opposite sides of the opening.

According to an aspect, the first stretch and the second stretch are asymmetrical relative to the axis of symmetry of the bushing.

The distance of the first stretch from the axis of symmetry of the bushing decreases along the main direction of extension towards the opening.

According to an aspect, the first stretch comprises a first portion (proximal to the base wall) that has concavity facing towards the axis of symmetry of the bushing.

According to an aspect, the first stretch comprises a second portion (proximal to the opening) that has concavity facing towards the side opposite to the axis of symmetry of the bushing.

According to an aspect, the first and the second portion blend smoothly into each other.

The distance of the second stretch from the axis of symmetry of the bushing decreases along the main direction of extension towards the opening.

According to an aspect, the second portion of the first stretch gives the pouch its contoured shape and delimits the handgrip portion of the dispensing system.

According to an aspect, the second stretch has concavity facing towards the axis of symmetry of the bushing.

According to an aspect, the base wall has a fold line.

According to an aspect, the first wall, the second wall and the base wall can be folded in bellows/concertina fashion at the base wall, which folds about the fold line.

According to an aspect, the base wall is foldable about the fold line between a position of minimum size and a position of maximum size.

When the dispensing system contains detergent, the base wall is fully extended and disposed in the position of maximum size.

According to an aspect, the base wall can expand on the side opposite the opening, in particular when the pouch is full of liquid product.

When the product is finished and the dispensing system needs to be discarded and disposed of as waste, the base wall can be folded and put in the position of minimum size.

Advantageously, having a flexible base wall, preferably having a fold line, allows reducing the size of the dispensing system when it has to be disposed of.

According to an aspect, the weld between the first wall and the base wall comprises a first polygonal portion and a second polygonal portion which are spaced and smoothly connected to each other.

According to an aspect, the weld between the second wall and the base wall comprises a first polygonal portion and a second polygonal portion which are spaced and smoothly connected to each other.

The polygonal portions may be triangular, for example.

At the polygonal portions, the weld can only extend at the sides of the polygons or also cover the surface delimited by the sides of the polygons, that is, the area of the polygons. Advantageously, shaped in this way, the welds between the first wall and the base wall and between the second wall and the base wall give rigidity/solidity to the supporting portion.

According to an aspect, the bushing comprises first coupling means and the sprayer comprises second coupling means.

Advantageously, the first and the second coupling means allow coupling the bushing (hence the pouch) to the sprayer.

For example, the first coupling means may comprise a threaded male portion and the second coupling means may comprise a threaded female portion.

According to an aspect, the first wall, the second wall, the base wall have a thickness between 30 μm and 80 μm.

Advantageously, making walls with this thickness makes the pouch rigid enough to ensure that the dispensing system can stand, that is remain in the vertical position, even when it is empty.

In an example, the first wall and the second wall are between 100 mm and 240 mm, preferably 190 mm, in height, and the base wall is between 100 mm and 170 mm, preferably 150 mm, in length.

In an example, the volume of product containable inside the pouch is 500 ml.

In another example, the volume of product containable inside the pouch is 750 ml.

According to an aspect, the pouch, the sprayer and the bushing may be made of the same material, such as polyethylene or polypropylene.

According to an aspect, the system may comprise a pouch made from a multimaterial, and a sprayer and bushing made from polyethylene or polypropylene.

Advantageously, making all the components of the dispensing system from the same plastic material facilitates disposal and recycling.

According to an aspect, this disclosure regards a cleaning device that comprises a dispensing system according to any of the above mentioned aspects and a liquid product.

The liquid product is placed inside the pouch and is dispensed by the sprayer of the dispensing system.

The liquid product in the pouch may be a household cleaning detergent or surface detergent or a detergent for personal hygiene or personal care.

### BRIEF DESCRIPTION OF THE DRAWINGS

The main features of the invention are more apparent from the detailed description which follows, with reference to the accompanying drawings which illustrate a preferred embodiment of the invention purely by way of non-limiting example, and in which:

FIG. 1 shows a schematic perspective view of a cleaning device comprising a dispensing system and a liquid product;

FIG. 2 shows a schematic front view of a dispensing system according to this disclosure;

FIG. 3 shows a schematic front view of a detail of the dispensing system of FIG. 2;

FIG. 4 shows a schematic front view of a detail of the dispensing system of FIG. 2.

### DETAILED DESCRIPTION OF PREFERRED EMBODIMENTS OF THE INVENTION

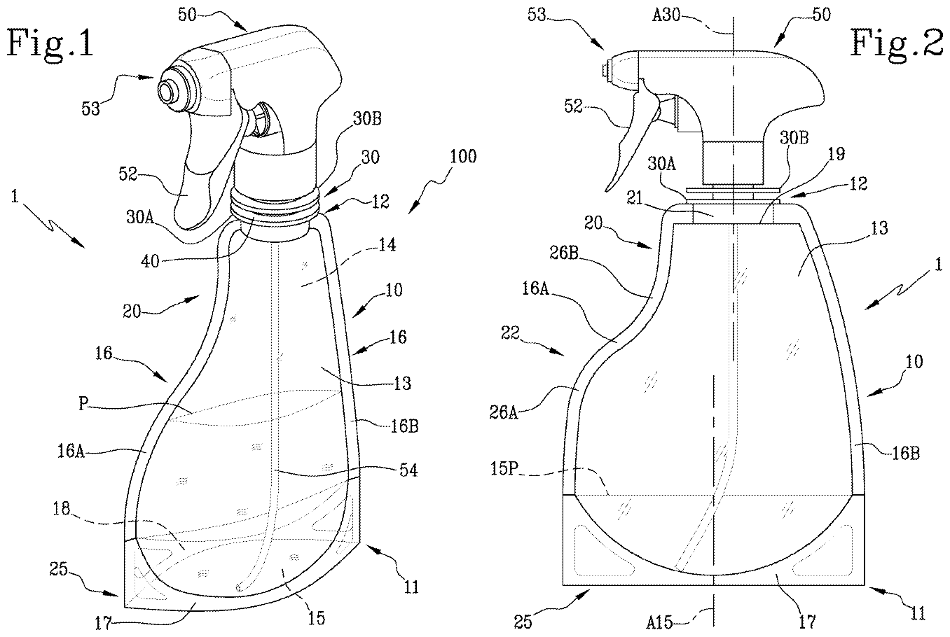

With reference to the accompanying drawings, in particular FIG. 1, the numeral 1 denotes a dispensing system for dispensing a liquid product P such as, for example, a surface detergent, to which specific reference is made below without loss of generality.

The dispensing system 1 comprises a pouch 10, made from film preferably comprising plastic material.

In an embodiment, the film is monomaterial, such as, for example, low-density polythene, polyethylene or polypropylene, thus making it easier to recycle.

In an embodiment, the film is multimaterial comprising, for example, low-intensity polythene, polypropylene and nylon.

In an embodiment, the film comprises monolayer film.

In an embodiment, the film comprises polylaminated and/or monolayer film.

In an embodiment, the polylaminated film may comprise paper and/or plastic material and/or aluminium.

In an embodiment, the polylaminated film may comprise paper and low-density polythene.

In an embodiment, the polylaminated film may comprise paper, low-intensity polythene, polypropylene and nylon.

Advantageously, a pouch made using a film requires less plastic than bottles made from rigid plastic.

The pouch 10 has a first end 11 and a second end 12.

In the example illustrated in FIG. 1, the end 11 is a bottom end and the end 12 is a top end.

The pouch 10 comprises at least a first wall 13, a second wall 14 and a base wall 15.

As illustrated, the walls 13 and 14 define side walls or flanks of the pouch 10.

The base wall 15 is disposed between the wall 13 and the wall 14 at the first end 11, which defines the bottom of the pouch.

The pouch 10 comprises a weld 16 for joining the wall 13 to the wall 14.

The pouch 10 comprises a weld 17 for joining the wall 13 to the base wall 15.

The pouch 10 comprises a weld 18 for joining the wall 14 to the base wall 15.

The wall 15, the weld 17 and the weld 18 define a supporting portion 25 for the dispensing system 1, at the end 11.

Advantageously, when the pouch is completely or partly full, it is supported, preferably by at least part of the wall 15 and the welds 17 and 18.

The base wall 15 can expand towards a supporting surface under the action of the product P inside the pouch.

Advantageously, when the pouch is empty or nearly empty, it is supported by at least part of the welds 17 and 18.

The wall 13, the wall 14 and the wall 15 delimit a containing space holding the liquid product P.

In an embodiment, the containing space holds, for example, 500 ml of product P.

In an embodiment, the containing space holds, for example, 750 ml of product P.

Advantageously, unlike conventional rigid bottles, the pouch 10 made this way is easy to flatten when it is empty and no longer contains any liquid product, thus reducing the space occupied by the pouch itself and/or the dispensing system and facilitating its disposal as waste.

The wall 13 and the wall 14 define an opening 19 in the pouch 10 at the end 12, on the side opposite the base wall 15.

The dispensing system 1 comprises a bushing 30 inserted in the opening 19.

The wall 13 and the wall 14 are joined to the bushing 30 at the opening 19, for example by a weld 21.

The dispensing system 1 comprises a sprayer 50 to dispense the liquid product P from the pouch 10; the sprayer 50 is of substantially known type and is described only insofar as necessary for understanding this disclosure.

The sprayer 50 is coupled to the bushing 30 on the side opposite the pouch 10.

The sprayer 50 is, for example, what is known as a trigger sprayer.

Advantageously, using a sprayer 50 allows distributing and regulating the amount of detergent dispensed from the pouch 10 to the surfaces, for example.

The sprayer 50, as illustrated in FIG. 4, essentially comprises a pumping assembly 51, a lever 52 for driving the pumping assembly 51, a diffuser unit 53 in communication with the pumping assembly 51.

The pumping assembly 51 comprises a hose 54 for drawing the liquid from the pouch 10.

In an embodiment, the length of the hose 54 is greater than the height (defined substantially as the distance between the first end and the second end 11 and 12) of the pouch 10.

Advantageously, providing the dispensing system 1 with a hose 54 that is longer than the height of the pouch 10 facilitates the stability of the dispensing system 1, in particular when the product is substantially empty.

The bushing 30 comprises first coupling means 35 and the sprayer 50 comprises second coupling means 55.

The bushing 30 can be coupled to the sprayer 50 by the first and second coupling means 35, 55.

In an embodiment, the first coupling means 35 comprise a threaded male portion and the second coupling means 55 comprise a threaded female portion.

Advantageously, the first and second coupling means 35, 55 allow coupling the sprayer 50 to the bushing 30, hence to the pouch 10.

In an embodiment, the bushing 30 comprises a collar 40.

In an embodiment, the bushing 30 comprises at least a first ring 30A protruding radially from the bushing 30 itself.

In an embodiment, the bushing 30 comprises a first ring 30A and a second ring 30B, both protruding radially from the bushing itself.

The second ring 30B is disposed between the collar 40 and the first ring 30A.

The first ring 30A and the second ring 30B define/delimit an annular groove, preferably symmetrical about the axis A30.

Advantageously, the first ring 30A and the second ring 30B define a groove in which it is possible to insert a fork of an industrial machine for filling the pouch 10.

Advantageously, the presence of a first and a second ring in the bushing allows the pouch to be filled by industrial means, making it possible to market a dispensing system that is ready-filled with liquid product.

Advantageously, a cleaning device comprising a dispensing system filled with product is easy to place on the shelves of large distribution chains.

Advantageously, once filled with product, the dispensing system is ready for sale off the shelf in large distribution chains.

The collar 40 is disposed in the opening 19, between the wall 13 and the wall 14.

The dispensing system 1 comprises the weld 21, which joins the wall 13 to the bushing 30 and the wall 14 to the bushing 30, specifically to the collar 40.

In a preferred embodiment, the pouch 10 has a taper 22 towards the end 12.

Preferably, the walls 13 and 14 converge towards the end 12 to define the taper 22 of the pouch 10.

Advantageously, the upward taper 22 allows making the dispensing system 1 more stable, not only when the pouch 10 is full of product but also when the product is nearly finished.

The taper 22 defines a handgrip portion 20 for the dispensing system 1.

Advantageously, the handgrip portion 20 makes it easier for the user to hold the system 1 and ensures an ergonomic grip.

The bushing 30 has an axis of symmetry A30.

In an embodiment not illustrated, the taper 22 of the pouch 10 is symmetrical about the axis A30.

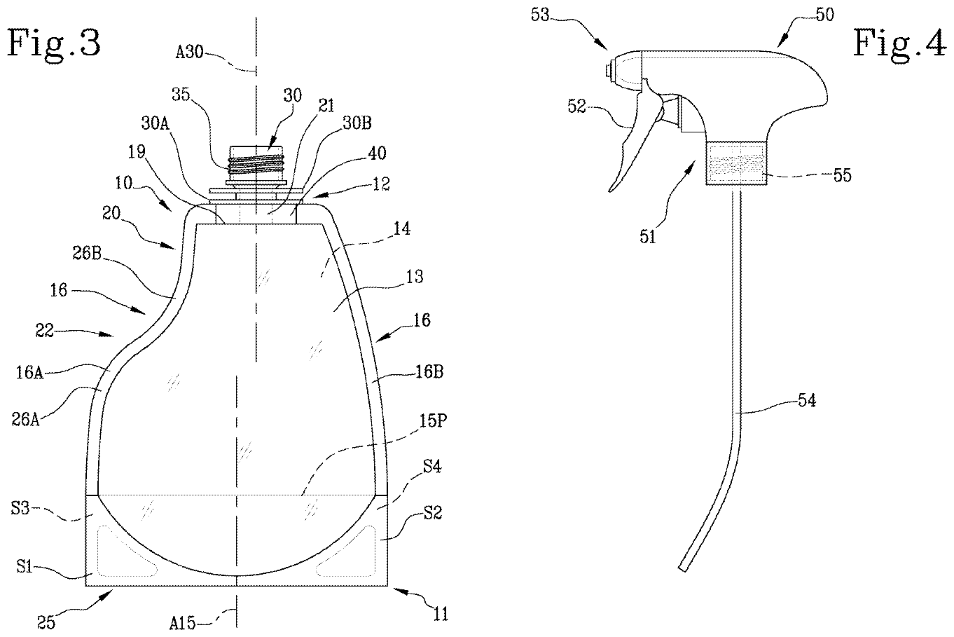

In an embodiment illustrated for example in FIGS. 2 and 3, the taper of the pouch 10 is asymmetrical relative to the axis A30.

The wall 13 is preferably symmetrical to the wall 14 about the axis A30.

In an embodiment, the wall 13 and the wall 14 have the same shape; the shape of the walls 13, 14 is preferably defined or delimited by the welds 16, 17, 18.

In a preferred embodiment, the base wall 15 has an axis of symmetry A15.

Preferably, the axis A15 is parallel to the axis A30, as illustrated in FIG. 3.

In an embodiment, the weld 16 has a first stretch 16A and a second stretch 16B; the stretch 16A extends on the side opposite the stretch 16B with respect to the opening 19.

In an embodiment not illustrated, the stretch 16A and the stretch 16B are symmetrical about the axis A30.

In an embodiment illustrated for example in FIG. 3, the stretch 16A and the stretch 16B are asymmetrical relative to the axis A30.

In the example illustrated, the stretch 16A contours the pouch 10 and delimits the handgrip portion 20 of the system 1; the stretch 16A defines the taper 22.

In an embodiment, the stretch 16A comprises a first portion 26A, proximal to the wall 15 and having concavity facing towards the axis A30.

In an embodiment, the stretch 16A comprises a second portion 26B, proximal to the opening 19 and having concavity facing towards the side opposite to the axis A30.

The first portion 26A and the second portion 26B blend smoothly into each other.

In an embodiment, the second portion 26B defines the taper 22 and, preferably, delimits the handgrip portion 20 of the system 1 by contouring the pouch 10.

In an embodiment, shown by way of an example in FIG. 3, the second stretch 16B has concavity directed towards the axis A30.

In a preferred embodiment, the base wall 15 has a fold line 15P.

The fold line 15P allows the wall 15 to be folded on itself.

The wall 15 is foldable about the fold line 15P between a position of minimum size (where the base wall is folded on itself) and a position of maximum size (where the base wall is substantially stretched out).

The walls 13, 14 and the base wall 15 can be folded in bellows/concertina fashion at the base wall 15, which folds about the fold line 15P.

Advantageously, having a flexible wall 15 allows reducing the size of the dispensing system 1 when it has to be disposed of.

In an embodiment, the weld 17 covers an area S1 and an area S2 which are spaced from each other along the base wall 15.

The areas S1 and S2 are blended smoothly into each other and preferably have the same shape.

In an embodiment, the weld 17, in the areas S1 and S2, has respective polygonal portions which blend smoothly into each other.

The polygonal portions may be triangular, for example.

At the polygonal portions, the weld 17 can only extend at the sides of the polygons, as in the example illustrated, or also cover the surface delimited by the sides of the polygons, that is, the area of the polygons.

Advantageously, shaped in this way, the welds between the wall 13 and the base wall 15 give rigidity/solidity to the supporting portion 25.

In an embodiment, the weld 18 covers an area S3 and an area S4 which are spaced from each other along the base wall 15.

The areas S3 and S4 are blended smoothly into each other and preferably have the same shape.

In an embodiment, the weld 18, in the areas S3 and S4, has respective polygonal portions which blend smoothly into each other.

The polygonal portions may be triangular, for example.

At the polygonal portions, the weld 18 can only extend at the sides of the polygons, as in the example illustrated, or also cover the surface delimited by the sides of the polygons, that is, the area of the polygons.

Advantageously, shaped in this way, the welds between the wall 14 and the base wall 15 give rigidity/solidity to the supporting portion 25.

In an embodiment, the areas S1, S2, S3 and S4 are disposed as illustrated in FIGS. 2 and 3.

In an embodiment, the areas S1 and S2 are symmetrical to the areas S3 and S4 about the axis A30.

Advantageously, the welds 17 and 18 shaped in this way allow making the dispensing system more stable.

Advantageously, the welding areas S1, S2, S3, S4 impart rigidity to the system 1.

In an embodiment, the pouch 10, the bushing 30 and the sprayer 50 are made from the same plastic material.

Advantageously, making the pouch 10, the bushing 30 and the sprayer 50 of the dispensing system 1 from the same plastic material makes it easier for the system 1 to be disposed of and/or recycled.

In an embodiment, the pouch 10, the bushing 30 and the sprayer 50 are made from polyethylene.

In an embodiment, the pouch 10, the bushing 30 and the sprayer 50 are made from polypropylene.

In an embodiment, the walls 13, 14 and 15 of the pouch 10 have a thickness between 30 μm and 80 μm.

Advantageously, walls between 30 μm and 80 μm thick contribute to imparting suitable rigidity to the pouch so that the system 1 can remain upright even when empty.

In an embodiment, the wall 13 and the wall 14 are between 100 mm and 240 mm in height.

In an embodiment, the wall 13 and the wall 14 are 190 mm in height.

Preferably, the maximum distance between the stretch 16A and the stretch 16B of the weld 16 defines a length for the wall 15.

Preferably, the stretches 12A and 12B extend from the end 11 to the end 12. The stretch 12A defines a first edge of the pouch 10 and the stretch 12B defines a second edge of the pouch 10.

In an embodiment, the wall 15 is between 100 mm and 170 mm in length.

In an embodiment, the wall 15 is 150 mm in length.

In an embodiment, the pouch 10 has a ratio of height of pouch 10 to length of wall 15 of between 1.20 and 1.35.

In an embodiment, the pouch 10 has a ratio of height of pouch 10 to length of wall 15 of 1.27.

Advantageously, making a pouch where the ratio of the height of the pouch itself to the length of its base wall is between 1.20 and 1.35 helps make the dispensing system stable even when the product inside it is nearly finished.

Also an object of this disclosure is a cleaning device 100, illustrated in FIG. 1, which comprises a dispensing system 1 according to any of the above mentioned features and a liquid product P.

The liquid product P is located inside the pouch 10.

Advantageously, the sprayer 50 allows drawing the liquid out of the pouch 10 and dispensing it.

In an embodiment, the liquid product P may be, for example, a surface detergent, a household detergent.

In another embodiment, the liquid product P may be a detergent for personal hygiene and/or for body care.

Advantageously, a cleaning device comprising a dispensing system filled with product is easy to place on the shelves of large distribution chains.

1. A system for dispensing a liquid product, comprising:
a pouch, made from film material, having a first end and a second end and comprising a first wall, a second wall and a base wall disposed between the first wall and the second wall at the first end, the pouch comprising a first weld joining the first wall to the second wall, a second weld joining the first wall to the base wall and a third weld joining the second wall to the base wall,
the first wall, the second wall and the base wall delimiting a containing space holding the liquid product,
the first wall and the second wall defining an opening in the pouch at the second end,
the dispensing system comprising a bushing inserted in the opening, the first and second walls being joined to the bushing at the opening, the bushing having a first axis,
the dispensing system comprising a sprayer for dispensing the liquid product from the pouch, the sprayer being coupled to the bushing and comprising a pumping assembly, a lever for driving the pumping assembly, a diffuser unit in communication with the pumping assembly.

2. The dispensing system according to claim 1, wherein
the pouch has a taper towards the second end, the taper defining a handgrip portion for the dispensing system.

3. The dispensing system according to claim 1, wherein the first and second walls are symmetrical about the first axis of symmetry.

4. The dispensing system according to claim 1, wherein the first weld comprises a first stretch and a second stretch extending from opposite sides of the opening.

5. The dispensing system according to claim 4, wherein the first stretch and the second stretch are asymmetrical relative to the first axis of symmetry.

6. The dispensing system according to claim 4, wherein the first stretch comprises a first portion having concavity facing the first axis of symmetry and a second portion having concavity facing the side opposite to the first axis of symmetry.

7. The dispensing system according to claim 2, wherein the second portion delimits the handgrip portion of the dispensing system by contouring the pouch.

8. The dispensing system according to claim 4, wherein the second stretch has concavity facing towards the first axis of symmetry.

9. The dispensing system according to claim 1, wherein the base wall has a second axis of symmetry.

10. The dispensing system according to claim 3, wherein the second axis of symmetry is parallel to the first axis of symmetry.

11. The dispensing system according to claim 1, wherein the pumping assembly comprises a hose for drawing the liquid from the pouch, the length of the hose being greater than the height of the pouch, measured between the first end and the second end.

12. The dispensing system according to claim 1, wherein the base wall has a fold line, the base wall being foldable about the fold line between a position of minimum size and a position of maximum size.

13. The dispensing system according to claim 1, wherein the second and third welds each have a first polygonal portion and a second polygonal portion which are smoothly connected to each other.

14. The dispensing system according to claim 1, wherein the bushing comprises a collar inserted in the opening.

15. The dispensing system according to claim 1, comprising a fourth weld, the fourth weld joining the first and second wall to the bushing.

16. The dispensing system according to claim 1, wherein the pouch, the bushing and the sprayer are made from the same plastic material.

17. The dispensing system according to claim 1, wherein the first wall, the second wall and the base wall have a thickness between 30 μm and 80 μm.

18. The dispensing system according to claim 1, wherein the film material comprises a polylaminated film and/or a single-layer film.

19. The dispensing system according to claim 1, wherein the bushing comprises at least a first ring protruding radially from the bushing itself.

20. The dispensing system according to claim 19, wherein the bushing comprises a second ring protruding radially from the bushing itself, the second ring delimiting with the first ring an annular groove which is preferably symmetrical about the axis of symmetry.

21. A cleaning device comprising a dispensing system according to claim 1 and a liquid product placed inside the pouch from where it can be dispensed through the sprayer.
